(19) United States
(12) Patent Application Publication
(10) Pub. No.: US 2014/0028070 A1
(43) Pub. Date: Jan. 30, 2014

(54) ADJUSTING DEVICE FOR ADJUSTING A MOTOR VEHICLE SEAT, MOTOR VEHICLE SEAT, MOTOR VEHICLE AND METHOD FOR ADJUSTING A MOTOR VEHICLE SEAT

(71) Applicant: GM GLOBAL TECHNOLOGY OPERATIONS LLC, Detroit, MI (US)

(72) Inventor: Andrzej PLESKOT, Trebur (DE)

(73) Assignee: GM Global Technology Operations LLC, Detroit, MI (US)

(21) Appl. No.: 13/746,071

(22) Filed: Jan. 21, 2013

(30) Foreign Application Priority Data
Jul. 25, 2012 (DE) 102012001280.2

(51) Int. Cl. B60N 2/23; B60N 2/22

(52) U.S. Cl. CPC B60N 2/23; B60N 2/22
USPC 297/354.12; 297/463.1

(57) ABSTRACT

An adjusting device for adjusting a motor vehicle seat is provided. The adjusting device includes at least two locking device and a joint actuating device configured to actuate the at least two locking devices. The at least two locking devices are connected in series with the joint actuating device. A motor vehicle seat, a motor vehicle, and a method for adjusting a motor vehicle seat using the adjusting device are also provided.

### CROSS-REFERENCE TO RELATED APPLICATION

This application claims priority to German Patent Application No. 10 2012 001 280.2, filed Jan. 25, 2012, and to German Patent Application No. 10 2012 014 897.6, filed Jul. 26, 2012, which are incorporated herein by reference in their entirety.

### TECHNICAL FIELD

The technical field relates to an adjusting device for adjusting a motor vehicle seat, a vehicle seat including the adjusting device, a motor vehicle including the vehicle seat and a method for adjusting a motor vehicle seat using the adjusting device.

### BACKGROUND

From the prior art, motor vehicles having seats are known, with which a backrest part or the position of the backrest, in particular with respect to a seat part, is adjustable. The adjustment is effected via a lever mechanism arranged on the seat or another actuating device fixed there. Here, stepless adjustments by means of actuators and discontinuous adjustment, i.e. step-by-step adjustment by means of mechanical solutions are known. With the mechanical adjustments, locking or arresting devices for locking or arresting are released or arrested. Conventionally, this is effected via a lever, via which a force is transmitted to an engagement fitting. Here, a force transmission is effected proportionally, i.e., a force to be transmitted increases with the lever distance or in the case of a rotary movement, the torque increases with the twisting angle. Because of intermediate positions of the engagement fittings, an adjusting is possible even with the engagement fitting not fully unlocked. Upon an adjusting in intermediate positions, undesirable side effects such as noise development during the adjusting or increased wear can occur. Levers for unlocking the locking device and thus of the adjusting device are usually seated directly on a rotation axis of the adjusting device.

From DE 38 00 924 C2 a vehicle seat having an adjusting device for a backrest is known. The adjusting device consists of a fixed-location bearing pedestal, a pivot arm pivotably mounted on the bearing pedestal, which is fastened to the backrest and can be fixed in selectable angular positions by means of a locking device. The adjusting device is covered by a covering part in the direction of the seat user. The bearing pedestal is fastened to the seat part and the remaining parts of the adjusting device are arranged within the backrest and connected with the latter. The covering part is connected to a part of the adjusting device in a fixed manner and comprises a slit, into which a region of the bearing pedestal projecting upwards dips when the backrest is folded forward.

The actuating device for the known adjusting device is directly arranged on the seat to be adjusted on the rotation axis of the adjusting device. The arrangement of the actuation is relatively un-ergonomical and accessible only with difficulty in cramped conditions. In addition, an adjusting characteristic of the adjusting device is unfavorable for the user.

Accordingly, at least one object herein is to provide a simpler and more comfortable adjusting solution. It is at least one object herein, in particular, to provide a motor vehicle, a motor vehicle seat, an adjusting device and a method thereto, with which the operating comfort for adjusting a seat is improved. In addition, other objects, desirable features and characteristics will become apparent from the subsequent summary and detailed description, and the appended claims, taken in conjunction with the accompanying drawings and this background.

### SUMMARY

In an exemplary embodiment, an adjusting device for adjusting a motor vehicle seat, in particular a discontinuous adjusting device for adjusting a backrest position of the motor vehicle seat or of a backrest part relative to a seat part of the motor vehicle seat, includes at least two locking devices, which can be actuated by way of at least one joint actuating device. The locking devices are connected in series with an operating unit.

The motor vehicle seat comprises a backrest or a backrest part and a seat part. The backrest part and the seat part are adjustably connected to each other via an adjusting device. In an embodiment, the adjusting device has a rotation axis, about which the backrest part can be pivoted or folded relative to the seat part, so that an angle can be adjusted between seat part and backrest part as desired by the user. In order to arrest the backrest part in a desired position, the adjusting device includes at least one locking device. Preferably, a locking device is provided on each side of the motor vehicle seat or the adjusting device.

Adjusting the backrest or the backrest part is effected through force applied to the backrest. In an exemplary embodiment, the backrest is preloaded, so that a preload force acts in the direction of an upright sitting position and against a pivoted-back position. In order to pivot the backrest, a force is preferably exerted by a user seated on the seat, preferably by leaning or pushing against the backrest. To prevent an unintentional adjustment of the backrest, the adjusting device comprises the locking device as blocking device or arresting device, which prevents the unintentional adjusting. The locking device is preferably configured as an engagement fitting unit, with which two engagement fitting parts act with one another. For adjusting, these have to be unlocked so that a seat adjustment can take place. The adjusting device comprises the engagement fitting unit. On locking, the two engagement fitting parts are engaged. In order to make adjusting possible, the engagement fitting parts are moved apart so that these are no longer engaged. The force or the movement required for this is transmitted via a force transmission device. During the relative movement of the two engagement fitting parts, there are different intermediate positions between the two end positions or end states—locking and release—during the moving-apart.

With some of these intermediate positions, adjusting is possible although the engagement fitting parts are still slightly engaged. In an embodiment, in order to move the engagement fitting parts apart, the force transmission device is provided, with which a force for locking and unlocking can be transmitted at least to the engagement fitting unit. Here, the force correspondingly results in a relative movement of the engagement fitting parts. In order to employ a force which is transmitted to the engagement fitting unit via the force transmission device so that adjusting only takes place when the engagement fitting parts are completely moved apart, a force step-up transmission device is provided. The force transmission device is designed to carry out the state in which the engagement fitting parts are completely clear of each other and adjusting is to be carried out without contact of the engagement fitting parts, faster and with a noticeable feedback to the operator.

The force transmission device and the force step-up transmission device are designed integrated in an embodiment. To this end, the transmitted force, which with the prior art is transmitted substantially proportional or linear to the distance, is stepped-up by means of the force transmission device, in particular, variably stepped up. Preferably, the step-up transmission is effected degressively, so that on reaching a decoupling point, i.e. a point or state in which the engagement fitting parts are completely no longer engaged, noticeably less force has to be exerted on the force transmission device, i.e. a corresponding feedback to the operator is provided. Here, the adjusting device is designed so that the force transmission device becomes easier to operate when the decoupling point or a decoupling state is reached. In an embodiment, one force transmission device is provided. In other embodiments, a plurality of force transmission devices is provided, for example two, three or more. In an embodiment, the plurality of force transmission devices is coupled, for example connected in series or connected in parallel.

A further embodiment provides a force step-up transmission device. Another embodiment provides a plurality of force step-up transmission devices.

In an embodiment, the plurality of force step-up transmission devices are coupled, for example connected in series or connected in parallel. The force step-up transmission device in an embodiment is designed as lever, gearing or the like, i.e. the force transmission device comprises a step-up transmission portion, with which a force is stepped up. However, the force is stepped up independently of an angle or a distance of the force transmission device, so that a predetermined ratio is always present. The force step-up transmission device provides an additional step-up transmission. In particular, the force step-up transmission device is designed such that different step-up transmission ratios can be realized. To this end, the force step-up transmission device is variable relative to the force transmission device, in particular moveable, for example translatorically and/or rotatorically movable.

In an exemplary embodiment, the adjusting device comprises two locking devices, one on each side of the motor vehicle seat. The locking devices each comprise a separate locking mechanism. In order for the locking devices to unlock the adjusting device synchronously, these are interconnected. Interconnection in an embodiment is carried out in parallel. Preferably, the locking devices are connected in series. In addition, a suitable synchronization is required for synchronous opening of the locking devices.

In an embodiment, each locking device comprises a lever unit, via which the locking device can be actuated. The lever unit is arranged in a rotationally fixed manner on a rotation axis of the locking device. Upon actuation, i.e. rotation of the lever unit, the rotation axis is co-rotated and the locking device unblocked, so that the backrest or the backrest part can be adjusted.

In a further embodiment, the lever units on different locking devices are designed differently to one another, so that each locking device has a different locking characteristic. In order for the individual locking devices which are connected in series to open synchronously, the individual lever units have to be configured differently. In particular, the lever units have different lever arms.

In yet another embodiment, the different lever units are coupled together by way of at least one pulling force element, in particular a control cable. For the serial connection of the locking devices connected in series, a pulling force element is preferentially provided. A pulling force element can be a cable-like element, which can be substantially subjected to tensile load, but not pressure. This can be employed in a space-saving manner in order to interconnect the locking devices in series. To this end, the control cable or any other cable-like element is connected to the respective lever of the locking device. The pulling force element is preferably arranged on a lever arm of the lever unit between rotation axis and end of the lever arm. In this way, different step-up transmission ratios can be adjusted via the selected lever arm.

A further embodiment provides that one of the lever units is coupled to the actuating device. In order to operate all locking devices via an actuating device or actuating unit, one of the locking devices is connected to the operating or actuating device, preferably via a lever unit. The operating device is preferentially connected with the lever unit via a pulling force element. The pulling force element is designed as cable-like element, in particular as a control cable. For connecting to the operating unit, the lever unit preferably comprises a further lever arm. By way of the second or further lever arm, a step-up transmission to the operating unit can be adjusted. Because of this, the operating unit can be arranged distant from the rotation axis of the locking device, so that the adjusting device is designed in a remotely operable manner. Preferably, the adjusting device is arranged at least partially in an easily accessible location away from the rotation axis or the seat or the backrest. Preferably, the remote-controlled adjusting device is easily accessible in a region that is easily accessible to the user seated on the seat, in particular within reach. By way of the one operating unit, all locking devices can be actuated. Since the different locking devices are connected in series, a locking characteristic superimposed from the individual locking characteristics is formed. Here, the superimposition is configured such that the individual locking characteristics are configured so that on the operating unit a degressive force-distance curve is obtained.

The force-distance curve is in particular non-linear and/or non-proportional, but preferably degressive or progressive in design. Here, the individual lever units can be dimensioned such that at the time of the decoupling of the engagement fitting parts, a force-distance curve dips downwards, i.e. a force to be exerted for a further movement becomes lower so that an operating unit that can be more easily operated is realized.

A further embodiment provides that at least one of the lever units comprises at least one rotary lever which is rotatable about a rotation axis, with which a force, in particular a torque, can be transmitted. In this way, a simple force step-up transmission device or force transmission device is realized. In particular, a force transmission device and a force step-up transmission device are realized in one component. In particular, an embodiment provides that the force step-up transmission device is configured integrated in the force transmission device.

Furthermore, in an embodiment, the part of the force transmission device that is near the engagement fitting comprises a lever unit that is rotatable about a rotation axis, with which the force can be transmitted to the engagement fitting unit. The embodiment as a rotatable lever unit is small in construction. Preferably, the rotatable lever unit comprises a drum or winding portion, about which a wire of a force bridging device can be wrapped or wound. Preferably, the force bridging device is configured as a control cable. Accordingly, a force is transmitted via a wire or another flexible, high tensile-strength material. Preferably, this wire is wound about the drum portion, in order to realize a suitable coupling to the rotatable lever near the engagement fitting. The drum portion preferably comprises a constant or alternatively a non-constant radius.

Furthermore, in an embodiment, a motor vehicle seat, in particular a motor vehicle seat with a backrest that can be adjusted relative to a seat part, comprising at least one adjusting mechanism for adjusting the backrest is provided. The adjusting mechanism is designed as adjusting device as described above. In an embodiment, the motor vehicle seat is configured as an individual seat. In another embodiment, the motor vehicle seat is configured as a seat bench. In an embodiment, the seat bench comprises a split backrest, which can be individually and/or jointly adjusted by way of an adjusting device as described above.

Furthermore, in another embodiment, a motor vehicle, in particular a passenger car, comprising at least one seat device for a vehicle occupant is provided. The seat device is configured as a motor vehicle seat as described above. The motor vehicle is for example a sedan, van, coupe, off-road vehicle, (mini) bus or the like.

In a further embodiment, a method for adjusting a motor vehicle seat by an adjusting device having at least two locking devices is provided. In an embodiment, the method is for adjusting a backrest position of the motor vehicle seat by a discontinuous adjusting device having two locking devices. The method includes transmitting a force for locking and unlocking the adjusting device to the locking devices by a common actuating device. The force transmission to the locking devices is carried out connected in series. The two locking devices of the adjusting device spaced from each other are interconnected via a control cable, so that these are connected in series. One of the locking devices is connected with an operating unit or actuating unit via a further control cable.

In order to unlock the two locking devices for adjusting the backrest part, the actuating device is actuated, preferentially rotated about a rotation axis. The generated torque or the generated force and/or movement is/are transmitted to a rotation axis of the first locking device via a first force transmission unit with an integrated step-up transmission unit, preferentially via a rotary lever with lever arms. Furthermore, because of the serial linking, the torque or the force and/or the movement are transmitted to the further locking devices. Each locking device has an individual force transmission device. Via these, the respective locking device is actuated so that the force transmission device, preferentially in the form of a lever unit, which is seated on the respective rotation axis of the locking device in a rotationally fixed manner, realizes a synchronous unlocking of the individual locking devices and thus of the adjusting device.

According to an embodiment, the force transmission comprises a stepping-up of the force. The stepping up of the force takes place individually set for each locking device so that a synchronous unlocking of all locking devices is ensured.

In yet another embodiment, the locking devices are actuated differently to one another, in particular are subjected to a different torque. This means that based on the different transmission ratios, the different locking devices rotate at different speed. Here, the transmission ratio is adjusted so that all locking devices open synchronously.

Accordingly, an embodiment provides that an opening of the plurality of locking devices takes place synchronously, i.e. coordinated with one another. The coordination is carried out by means of the lever units and their shape.

In addition, a further embodiment provides that the stepping-up transmission comprises a superimposition of the transmission ratios of the locking devices, so that the actuating device has a non-progressive characteristic. The locking units without lever units all have a progressive adjusting characteristic.

Through the superimposition of the different adjusting characteristics, a desired adjusting characteristic on the operating lever can be adjusted.

Transmission, for a part, is effected via levers, which have fixed force-distance characteristics and with which a force transmission takes place dependent on a distance according to a fixed force-distance curve. In order to configure a time of a complete decoupling of the engagement fitting part clearly perceptibly to an operator, it is provided, at least in the meantime, to step-up the force transmission so that at least one change occurs in a force-distance curve. It is provided, in particular, that the force to be generated for releasing the adjusting device noticeably diminishes at the time of the complete decoupling of the engagement fitting parts. Accordingly, the transmission ratio is embodied so that a resistance is perceptibly diminished as soon as the deep coupling time is reached.

For this reason, an embodiment therefore provides in particular that the stepping-up comprises a degressive stepping-up at least partially. Because of this, a liner force-distance curve or a rising force-distance curve has a descending curve on commencement of the degressive transmission.

### BRIEF DESCRIPTION OF THE DRAWINGS

The various embodiments will hereinafter be described in conjunction with the following drawing figures, wherein like numerals denote like elements, and wherein:

FIG. 1 is a perspective view of an adjusting device having two locking devices, in accordance with an exemplary embodiment;

FIG. 2 is a lateral view of a detail of a motor vehicle seat with the adjusting device according to FIG. 1;

FIG. 3a is a perspective view of a side of the adjusting device of FIG. 1 with a first locking device in accordance with an exemplary embodiment;

FIG. 3b is a perspective view of another side of the adjusting device of Fig. with a second locking device in accordance with an exemplary embodiment;

FIG. 4 is a basic sketch of the adjusting device with different force-distance characteristics in accordance with an exemplary embodiment;

FIG. 5a is a diagram of different force-distance curves of different components of the adjusting device of FIG. 1; and

FIG. 5b is a diagram of a force-distance curve of the operating unit of the adjusting device of FIG. 1.

### DETAILED DESCRIPTION

The following detailed description is merely exemplary in nature and is not intended to limit the various embodiments or the application and uses thereof Furthermore, there is no intention to be bound by any theory presented in the preceding background or the following detailed description.

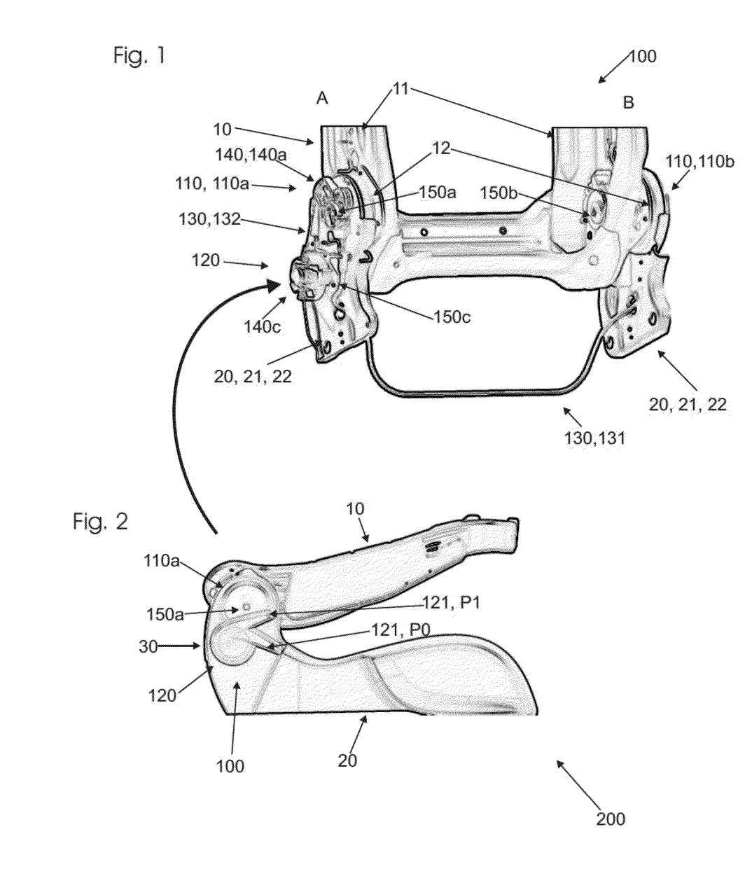

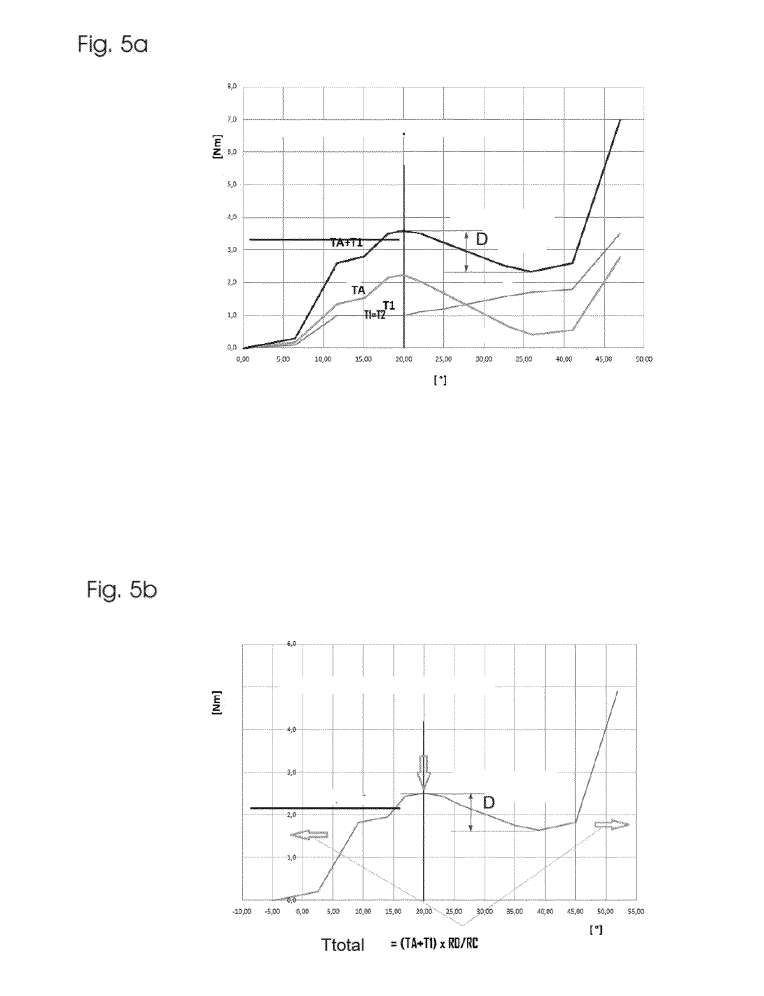

FIGS. 1 to 4 show an exemplary embodiment of an adjusting device 100 in different views and different degrees of detail. FIGS. 5a and 5b show force-distance curves on certain components of the adjusting device 100.

In an exemplary embodiment, the adjusting device 100 connects a backrest part 10 of a motor vehicle seat 200 with a seat part 20 of the motor vehicle seat 200. Here, the backrest part 10 and the seat part 20 are foldably connected to or relative to each other via the adjusting device 100. The backrest part 10 and the seat part 20 are configured in two parts, wherein the backrest part 10 comprises two laterally spaced backrest part portions 11 and the seat part 20 to corresponding laterally spaced seat part portions 21. In the embodiment shown here, the backrest part 10 additionally comprises a backrest adaptor part 12 on each lateral portion 11. Accordingly, the seat part 20 comprises a seat adaptor part 22 on each lateral portion 21. In the embodiment shown here, the seat adaptor parts 22 are integrated in the lateral portions 21, i.e. unitarily formed with these. On each side, the adjusting device 100 comprises a locking device 110. On a first side A, a first locking device 110a is formed. On a second side B a second locking device 110b is formed.

The locking devices 110 each comprise two engagement fitting units, which upon a blocking through the locking devices 110, are engaged with each other and accordingly are not engaged for an unlocking of the locking devices 110. A detailed description of the adjusting device 100 is made in the following in connection with the FIGS. 1 to 5b. Same or similar components are designated with same reference characters. A comprehensive description of already described components is omitted for the sake of better clarity.

FIG. 1 schematically shows an embodiment of adjusting device 100 with two locking devices 110 in a perspective view. The two laterally spaced locking devices 110a and 110b are designed differently from one another. In order to actuate both locking devices 110 jointly via a joint actuating unit or operating unit 120 and thus actuate the entire adjusting device 100 via the one common operating unit 120, the two locking devices 110 are coupled to each other. Here, the locking devices 110 are connected in series. This means, the locking device 110b is coupled to the locking device 110a via a pulling force element 130, which in this case is embodied as control cable 131.

In an embodiment, the locking device 110a is coupled to the operating unit 120. Coupling the operating unit 120 to the locking device 110a in this case is likewise effected via a pulling force element 130, which in this case is likewise embodied as control cable 132.

In another embodiment, for actuating the locking devices 110, each of the locking devices 110 comprises a lever unit 140, of which in this case only the lever unit 140a on the A side is noticeable. The first locking device 110a comprises a first lever unit 140a. The second locking device 110b comprises a second lever unit 140b. The respective lever units 140 are each arranged on a rotation axis 150 of the respective locking device 110. Here, the first lever unit 140a is connected to a first axis of rotation 150 in rotationally fixed manner. The second lever unit 140b is connected to a second rotation axis 150b in a rotationally fixed manner. The two rotation axes 150a, 150b are not connected to each other. When the respective lever unit 140 is now rotated, the corresponding rotation axis 150 is likewise co-rotated with the former, as a result of which the corresponding locking device 110 is unlocked or blocked. Here, the respective engagement fitting of the locking device 110 has a progressive force-distance characteristic, as is described further back in connection with FIG. 5a.

The lever units 140 each comprises at least one lever arm, via which a force step-up transmission can be realized. Though the lever unit 140 simultaneously acts as force step-up transmission unit and force transmission unit, any force-distance characteristic can be adjusted on the respective locking device 110. According to FIG. 1, the two lever units 140 of the two locking devices 110 are interconnected via the control cable 131, so that a movement of a lever unit 140 is transmitted to the other lever unit 140. The first lever unit 140a is furthermore connected to a third lever unit 140c of the operating unit 120 via the control cable 132. As with both the other lever units 140a and 140b, the lever unit 140c is configured as rotatable lever unit 140.

While the two rotation axes 150 of the lever units 140a and 140b are arranged aligned with each other in the shown exemplary embodiment, wherein in other embodiments other arrangements such as non-aligned arrangements are conceivable, the third lever unit 140c is rotatable about another, third rotation axis 150c. The rotation axis 150c is formed on the lateral part 21. The third lever unit 140c sits rotatably on the rotation axis 150c. Via the control cable 132, the operating unit 120 can be arranged at any point. In an embodiment, the operating unit 120 is arranged on the motor vehicle seat. By actuating the operating unit 120, the lever unit 140c is rotated. The movement or the rotational force is transmitted via the control cable 132 to the first lever unit 140a and from there to the second lever unit 140b via the control cable 131. The respective lever units realize the corresponding force step-up transmission. In this way, a series connection of the two locking devices 110a and 110b is realized.

FIG. 2 schematically shows a detail of a motor vehicle seat 200 in a lateral view with the adjusting device 100 according to FIG. 1. In this view, the motor vehicle seat 200 is folded, i.e. the backrest part 10 is folded or pivoted in the direction of the seat part 20 about the two rotation axes 150a and 150b of the two locking devices 110. To this end, the operating unit 120 configured as operating lever 121 has to be moved from a starting position P0 to an operating position P1. Moving is effected by pivoting about the third rotation axis 150c. Through a resetting mechanism, the operating lever 121 is pivoted back into its starting position P0. The further construction from FIG. 1 is not shown here because of the panel 30.

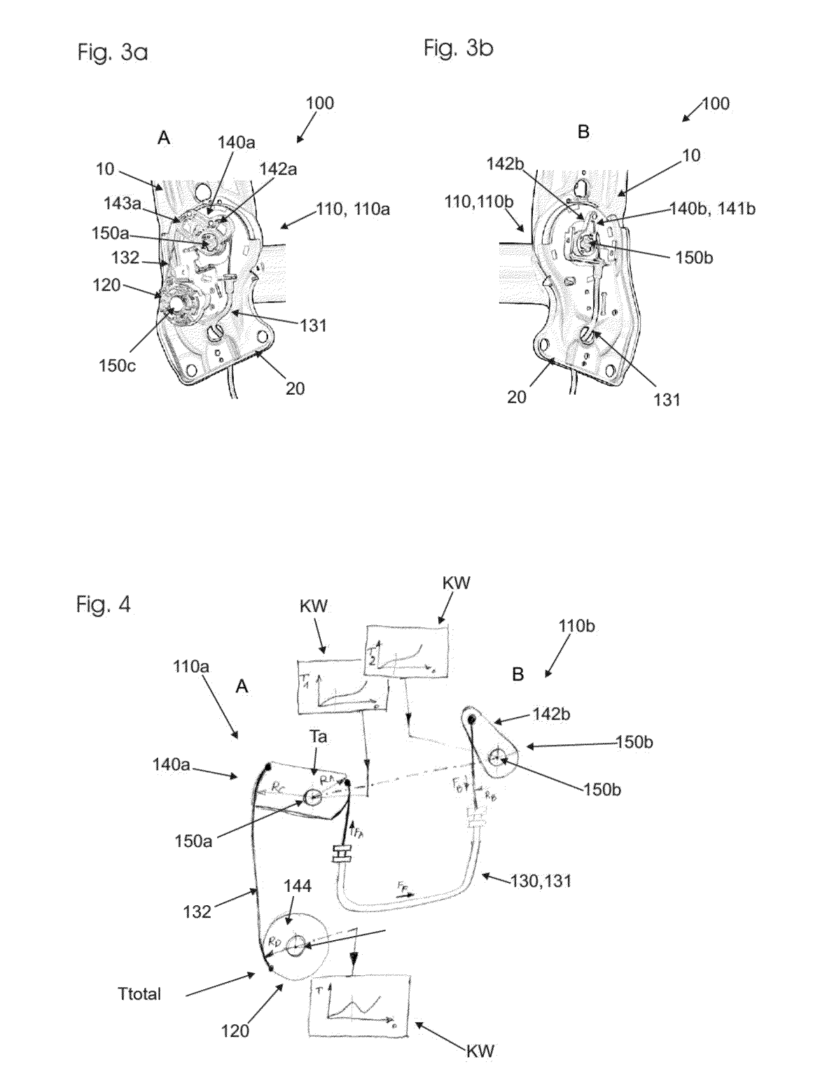

FIG. 3a schematically shows a first side A of the adjusting device 100 with the first locking device 110a in a perspective view.

FIG. 3b schematically shows another side B of the adjusting device 100 with a second locking device 110b in a perspective view.

FIG. 4 schematically shows a function diagram of the adjusting device 100 with different force-distance characteristics of individual components.

In an embodiment, the two locking devices 110 are constructed substantially equal, even if constructed in mirror image. The difference between the two locking devices 110 lies in the different lever units 140a, 140b, by which the originally same distance-force characteristic of the locking devices 110 is distinguished. On the second side B the lever unit 140b is designed as rotary lever 141b. The rotary lever 141b is arranged on the rotation axis 150b of the locking device 110b in a rotationally fixed manner. A lever arm 142b projects radially to the outside. At an outer end of the lever arm 142b, the control cable 131 is fastened. Depending on the position of the lever arm 142b, it transmits a torque to the rotation axis 150b via the force introduced by the control cable 131. The locking device 110 is unlocked and/or blocked via this.

On the first side A, the lever unit 140a is likewise configured as rotary lever 141a. The rotary lever 141a is arranged on the rotation axis 150a of the locking device 110a in a rotationally fixed manner. A lever arm 142a and a lever arm 143a radially project to the outside. On the lever arm 142a, the control cable 131 is fastened. On the lever arm 143a, the control cable 132 is fastened. Depending on the position of the lever arm 143a, the latter transmits a torque to the rotation axis 150a via the force introduced by the control cable 132. Stepped up by the lever arm 142a, the torque is passed on to the locking device 110b via the control cable 131.

FIG. 4 exemplarily shows the force step-up transmission and the resultant force-distance characteristic KW by means of a position of the lever arms 142a, 142b, 143a, which also includes a torque-angle characteristic.

In the shown position, T1 constitutes a torque on the second side B, T2 constitutes a torque on the first side A. The torque T1 is the non-stepped-up torque of the locking device 110b, which has a progressive force-distance characteristic. Because of the lever arm 142a, a stepped-up torque Ta is transmitted to the locking device 110a. Here, Ta is obtained as product of the pulling force Fa transmitted by the control cable 131 and the distance of the force introduced at the end of the lever arm 142a in force introduction direction Ra to Ta=Fa×Ra. The force Fa, which is transmitted via the control cable 131, is equal to the sum of the force Fb and the friction force of the control cable Ff. The force Fb is thus transmitted to the locking device 110b. In addition, the force acting on the side B is obtained as Fb=T2/Rb, wherein Rb corresponds to the distance of the force introduction of Fb at the end of the lever arm 142b in force introduction direction.

For the torque on the side A, this produces: Ta=((T2/Rb)+FF)×Ra. From this it follows that the torque Ta=T2×Ra/Rb+FF×Ra. Via the ratio of the distances Ra and Rb or of the length of the lever arms 142a, 142b, 143 and the arrangement of the control cable ends thereon, the force step-up transmission can be adjusted. Here, Ra and Rb change because of the rotation of the lever arms 142, since the control cable 131 is locationally fixed and the lever arms 142 accordingly rotate about the rotation axes 150.

Because of the step-up transmission and the serial arrangement and the superimposition of the individual force-distance characteristics for the operating unit 120 resulting from this, a torque Ttotal with degressive force-distance characteristic KW is present on the operating unit 120. In order to limit the torque Ttotal on the operating unit 120 to a comfortable dimension, the second lever arm 143a and a further lever arm 144 are provided on the operating lever. The lever arms have the distance to the force introduction of Rc and Rd respectively. By way of the ratio Rc/Rd, the resultant torque on the operating unit can be adjusted. Preferentially, the torque Ttotal on the operating unit is below 3.5 Nm, preferably below 3 Nm, in the present case at 2.5 Nm.

FIG. 5a schematically shows in a diagram different force-distance curves KW of different components of the adjusting device 100 and FIG. 5b schematically shows in a diagram a force-distance curve of the operating unit 120 of the adjusting device 100.

The force-distance curves each characterize a torque characteristic of components of the adjusting device 100. T1 and T2 characterize the torque curve over the angle of the engagement fitting units, i.e. the locking device 110 without lever step-up transmission. Ta characterizes the torque curve on the locking device 110a based on the lever step-up transmission. Ta+T1 characterizes the superimposed torque curve on the side A. The diagram shows on the abscissa the distance, which has to be generated upon an actuation of the adjusting device 100 for an adjustment, here in the form of a rotation angle with the unit degree. On the ordinate, the force to be generated over the distance is plotted, here plotted as torque with the unit Nm. The abscissa is divided into 5° steps with an auxiliary grid. The ordinate is divided into 1-Nm steps.

Up to a rotation angle of approximately 6-7°, the torques proceed almost with no force expenditure or in this case a force expenditure slightly rising to approximately 0.4 Nm. The force curve over the distance is linearly rising. At approximately 6-7°, a kink in the force-distance curve occurs and the curve up to approximately 12° increases more sharply to approximately 1 Nm for T1 and T2, approximately 1.3-1.4 Nm for Ta and to approximately 2.6 Nm for Ta+T1, in particular substantially linearly. The force transmission to the engagement fitting units substantially commences here, wherein the engagement fitting parts are separated from each other. Up to approximately 12° to approximately 20°, a uniform force is noticeable for T1 and T2. At Ta and T1, the force up to approximately 15° rises slightly flatter than previously to approximately 1.6 (Ta) and 2.8 (Ta+T1). Thereafter, the force initially rises more sharply (up to approximately 17°) and thereafter flatter (up to approximately 20°) to a local maximum (Ta approximately 2.2 Nm, and Ta+T1 approximately 3.6 Nm).

The engagement fitting parts move away from each other and are less and less in mutual engagement. At approximately 20°, the engagement fitting parts are completely no longer engaged, which constitutes the time or the location of an optimal adjusting. From here, the force-distance curves that ran substantially equal up to that point now run differently. While at T1 and T2 the force-distance curve continues to uniformly rise approximately linearly, up to approximately 42° more slightly, than from 42° more sharply, the force-distance curve according to an embodiment is subjected to a downward curve, i.e. the force over the distance drops up to approximately 36° to approximately 0.4 Nm (Ta) and 2.3 Nm (Ta+T1). This drop is marked with D. The curve only rises slowly from approximately 35°—up to approximately 42°, then steeply. The force drop D is clearly noticeable to the user. As soon as this force drop D is perceptible, the user can adjust the backrest without problem.

Accordingly, the force-distance curve shown in FIG. 5b is obtained on the operating unit 120. Starting out from a rotation angle of −10°, the torque Ttotal commences to slightly rise linearly from 0° to approximately 0.2 Nm even at −5° rotation to 2.5°. From 2.5°, the torque rises steeply and linearly to approximately 8° to approximately 8.8 Nm. There, the curve is subjected to a flattening and up to approximately 14°, rises more flatly linearly to approximately 1.9 Nm. From 14° to approximately 17°, a linear steeper curve to approximately 2.5 Nm occurs which remains almost constant in a range from 17° to approximately 23°. At 20°, a local maximum of the torque is reached with 2.5 Nm. Here, the complete unblocking of the locking devices 110 takes place. From 23°, the torque Ttotal drops slightly linearly to approximately 1.7 Nm at 38°, from where the torque Ttotal initially rises slightly linearly to 1.9 Nm at 45° and thereafter steeply linearly.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. An adjusting device for adjusting a motor vehicle seat, the adjusting device comprising:
at least two locking devices; and
a joint actuating device configured to actuate the at least two locking devices, wherein the at least two locking devices are connected in series with the joint actuating device.

2. The adjusting device according to claim 1, wherein the adjusting device is a discontinuous adjusting device for adjusting a backrest position of the motor vehicle seat.

3. The adjusting device according to claim 1, wherein each of the at least two locking devices comprises a lever unit via which the at least two locking devices can be actuated.

4. The adjusting device according to claim 1, wherein each of the at least two locking devices comprises a lever unit and wherein the lever units on the at least two locking devices are configured differently to each other so that each of the at least two locking devices has a different locking characteristic.

5. The adjusting device according to claim 4, wherein the lever units are coupled to one another via a pulling force element.

6. The adjusting device according to claim 5, wherein the pulling force element is a control cable.

7. The adjusting device according to claim 6, wherein one of the lever units is coupled to the joint actuating device.

8. The adjusting device according to claim 4, wherein the lever units are matched to one another so that, because of lever ratios, the joint actuating device has a non-progressive force-distance ratio.

9. The adjusting device according to claim 4, wherein at least one of the lever units comprises a rotary lever that is rotatable about a rotation axis and with which a force can be transmitted.

10. The adjusting device according to claim 9, wherein the force is a torque.

11. A motor vehicle seat having an adjusting device for adjusting the motor vehicle seat, the adjusting device comprising:
at least two locking devices; and
a joint actuating device configured to actuate the at least two locking devices, wherein the at least two locking devices are connected in series with the joint actuating device.

12. The motor vehicle seat according to claim 11, wherein the motor vehicle seat has a backrest adjustable with respect to a seat part and the adjusting device is configured for adjusting the backrest of the motor vehicle seat.

13. A motor vehicle comprising a seat for a vehicle occupant, wherein the seat has an adjusting device for adjusting the seat, the adjusting device comprising:
at least two locking devices; and
a joint actuating device configured to actuate the at least two locking devices, wherein the at least two locking devices are connected in series with the joint actuating device.

14. The motor vehicle according to claim 13, wherein the motor vehicle is a passenger motor vehicle.

15. A method for adjusting a motor vehicle seat by an adjusting device having at least two locking devices, the method comprising the steps of:
transmitting a force for locking and unlocking the adjusting device to the at least two locking devices by a joint actuating device, wherein a force transmission to the at least two locking devices is carried out in series.

16. The method according to claim 15, wherein the adjusting device is a discontinuous adjusting device and the method results in adjusting a backrest position of the motor vehicle seat.

17. The method according to claim 15, wherein the force transmission comprises a stepping-up of the force.

18. The method according to claim 17, wherein the stepping-up comprises a superimposing of stepped-up transmissions of the at least two locking devices so that the joint actuating device has a non-progressive characteristic.

19. The method according to claim 15, wherein the at least two locking devices are subjected to a different torque.

20. The method according to claim 15, wherein an opening of the at least two locking devices is effected synchronously.
